(19) United States
(12) Patent Application Publication
(10) Pub. No.: US 2013/0142996 A1
(43) Pub. Date: Jun. 6, 2013

(54) USE OF NANOPARTICLES FOR THE LONG-TERM "DRY" STORAGE OF PEROXIDE RADICALS

(71) Applicants: Olivier Poncelet, Grenoble (FR); Julien Jouhannaud, Volgre (FR)

(72) Inventors: Olivier Poncelet, Grenoble (FR); Julien Jouhannaud, Volgre (FR)

(73) Assignee: COMMISSARIAT A L'ENERGIE ATOMIQUE ET AUX ENERGIES ALTERNATIVES, Paris (FR)

(21) Appl. No.: 13/704,370

(22) PCT Filed: Jun. 15, 2011
(86) PCT No.: PCT/IB2011/052594

§ 371 Date: Feb. 22, 2013

(30) Foreign Application Priority Data
Jun. 16, 2010 (FR) 1002542

(51) Int. Cl. C09K 15/02; B32B 5/16

(52) U.S. Cl. CPC C09K 15/02; B32B 5/16
USPC 428/143; 423/273

(57) ABSTRACT

The invention relates to an agent for stabilising peroxide ions in the air. Said agent is, according to the invention, an aluminosilicate polymer such as imogolite and/or allophane. The invention can be used in particular in the field of anti-bacterial and oxidising agents.

The invention relates to the use of particles of an aluminosilicate polymer of the imogolite and/or allophane type as an agent for stabilizing peroxide ions in the air.

It also relates to a method of stabilizing peroxide ions in the air as well as the substrate obtained by said method.

Finally, it relates to a device, in particular a heat exchanger, comprising a substrate according to the invention.

The peroxide radicals (ions) are known to be very reactive and capable of oxidizing numerous compounds.

That is why they are used in particular as antibacterial agents and for carrying out many oxidation reactions.

However, these peroxide radicals can only exist in equilibrium in solution.

However, once the medium is open, i.e. in contact with the air, the dismutation reaction begins according to the following reactions:

H₂O₂+2H⁺+2e⁻=2H₂O (where H₂O₂ is the oxidant)

H₂O₂=O₂+2H⁺+2e⁻ (where H₂O₂ is the reductant)

2 H₂O₂→2 H₂O+O₂

As the release of oxygen quickly shifts the equilibrium, the peroxide radicals disappear.

The kinetics of the dismutation phenomenon can be greatly increased by the presence of certain chemical impurities present on the surface of the container.

Thus, until now it has been impossible to store peroxide ions available on the surface of a material in an open environment.

Moreover, aluminosilicate polymers of the imogolite type or of the allophane type are known.

These aluminosilicate polymers are known in various forms.

For example, aluminosilicate polymers are known in fibrous form, such as imogolite.

Imogolite is a filamentous, tubular aluminosilicate, occurring naturally in volcanic ash and in certain soils.

Natural imogolite is impure and is mixed with other aluminosilicates such as allophanes and/or boehmite.

However, in the natural state it is an impure product and therefore cannot be used in applications as antibacterial agent or as oxidizing agent in reactions requiring high purity.

There are various methods of synthesis of imogolite of varying purity. For example, Farmer's patents U.S. Pat. Nos. 4,152,404 and 4,252,779 describe a method of preparing an inorganic material analogous to natural imogolite.

Charge species, such as salts, are removed from the imogolite obtained by dialysis. However, this technique cannot remove allophanes, which do not carry charges.

Moreover, WADA et al., in Journal of Sol Science, 1979, 30, 347, describe a pure imogolite with an Al/Si molar ratio close to 2. It is specified here that the terms “very high purity” or “high degree of purity” denote an aqueous solution containing at least 80 wt %, and preferably at least 90 wt %, of imogolite.

European patent 0 741668 describes a long and detailed method for obtaining imogolite having a high degree of purity. Notably, it is absolutely necessary, during the step of digestion or of growth of the filaments, to maintain the pH and the Al+Si concentration in very precise ranges of values. In uncontrolled synthesis, the formation of silica gels, boehmite or allophanes is observed. Boehmite has a nonfibrous structure, with an Al:Si molar ratio above 4.

Thus, when the synthesis has not been controlled adequately, the imogolite obtained is not sufficiently pure for applications as antibacterial agent or as oxidizing agent in reactions requiring high purity.

French patent application 2 817 488 describes a method for obtaining an aluminosilicate polymer of the imogolite type of high purity usable in the formulation of polymer materials by purification of an aqueous dispersion of a mixture of colloidal particles of aluminosilicates obtained according to the method described in European patent 0 741 668. Thus, the mixture of colloidal particles is purified by ultrafiltration to obtain, in the retentate, a fibrous aluminosilicate polymer, of the imogolite type, having an Al/Si molar ratio between 1.8 and 2.5. Preferably, the ultrafiltration is a tangential ultrafiltration, also preferably using a membrane based on polyethersulfone. Preferably, the laminar flow in the retentate is roughly equal to 1 L.min⁻¹ for a membrane surface area of 1 m². The mixture of particles can also be pre-filtered before carrying out the ultrafiltration step.

French patent application 2 802 912 describes a method for preparing an aluminosilicate polymer of the imogolite type of high purity.

This method comprises the following steps:
a) treating a mixed alkoxide of silicon and aluminum, or a precursor of a mixed compound of aluminum and silicon, with an aqueous alkali, at a pH between 4.5 and 6.5 inclusive, maintaining the molar concentration of aluminum between 5.10⁻⁴ and 10⁻² mol.L⁻¹ inclusive, and the Al/Si molar ratio between 1 and 3 inclusive, in the presence of silanol groups,
b) carrying out a ripening step at room temperature, preferably for a time between 5 and 15 days inclusive, more preferably for a time between 8 and 10 days inclusive,
c) heating the mixture obtained in step a) at a temperature below 100° C., preferably at a temperature of 96-98° C. for 24 hours,
d) removing the residual ions from the mixture obtained in step c), for example by ultrafiltration.

The details of this method are given in French patent application 2 802 912.

Thus, in the present text, the terms “pure aluminosilicate polymer(s) of the imogolite type” denote the aluminosilicate polymers obtained by the methods described in French patent application 2 817 488 and French patent application 2 802 912, and are those used in the invention when high purity is necessary, especially when the application is an antibacterial application or for oxidation reactions by which products of high purity are to be obtained.

Aluminosilicate polymers in the form of spherical particles, such as allophanes, are also known.

As mentioned above, allophanes also occur naturally in combination with natural imogolite.

However, in the natural state it is an impure product, which therefore cannot be used in applications as antibacterial agent and as oxidizing agent in reactions requiring high purity.

The patent application U.S. Pat. No. 6,254,845 describes a method of preparing hollow spheres of aluminosilicate polymers of the allophane type. However, because of the method of manufacture used, the aluminosilicate polymer obtained contains a high proportion of the salt used for its formation.

French patent application 2 842 514 describes a method for preparing a very pure aluminosilicate polymer of the imogolite type or of the allophane type, which can be used for the formulation of numerous polymer materials.

This method consists of:
a) treating a mixed alkoxide of aluminum and of silicon that only has hydrolyzable functions (i.e. that only has substituents removed by hydrolysis during the process, and in particular on treatment with an aqueous alkali), or a mixed precursor of aluminum and of silicon obtained by hydrolysis of a mixture of aluminum compounds and silicon compounds that only has hydrolyzable functions, with an aqueous alkali, in the presence of silanol groups, the concentration of aluminum being kept below 0.3 mol.L⁻¹, the Al/Si molar ratio being maintained between 1 and 3.6 and the alkali/Al molar ratio being maintained between 2.3 and 3,
b) stirring the mixture obtained at room temperature in the presence of silanol groups for a sufficient time to form the aluminosilicate polymer, and finally
c) removing the byproducts formed during the preceding steps from the reaction mixture. The byproducts can be removed by various methods that are known per se, such as washing or diafiltration or ultrafiltration, preferably tangential ultrafiltration.

The details of this method are given in French patent application 2 842 514.

The aluminosilicate polymer of the imogolite type or of the allophane type obtained is characterized by a Raman spectrum comprising, in the 200-600 cm⁻¹ range, a broad band located at 250±5 cm⁻¹, an intense broad band located at 359±4 cm⁻¹, a shoulder located at 407±7 cm⁻¹, and a band located at 501±2 cm⁻¹, the Raman spectrum being performed on the material obtained just before the step in which the byproducts formed during steps a) and b) are removed from the reaction mixture.

French patent application 2 842 514 describes this method and the conditions for obtaining the Raman spectrum.

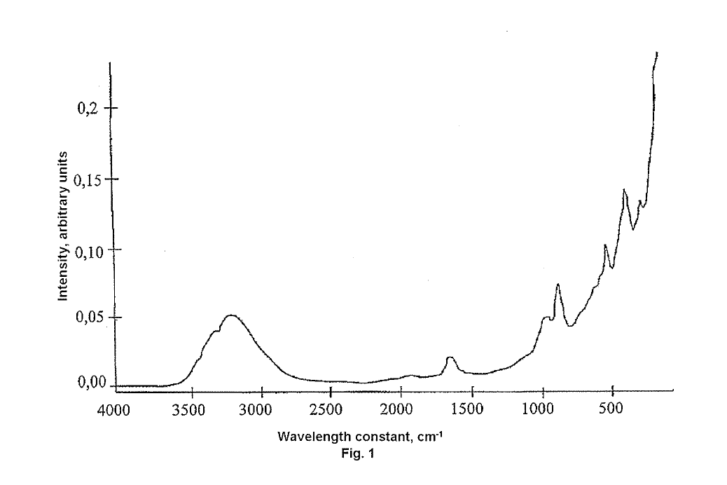

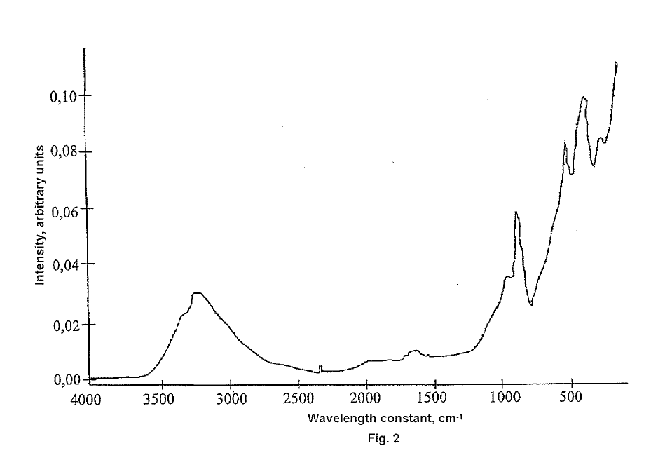

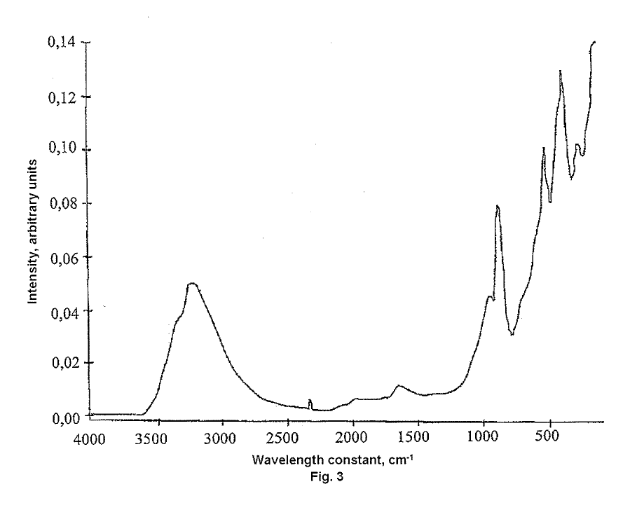

The accompanying FIGS. 1 to 3 show the Raman spectra of three aluminosilicate polymers used in the invention. It can be seen from these figures that the Raman spectrum of the aluminosilicate polymers used in the invention is indeed characterized as described above.

Thus, the terms “pure aluminosilicate polymer(s) of the imogolite type or of the allophane type” denote, in the present text, the aluminosilicate polymers obtained by the method described in French patent application 2 802 912 or by the method described in French patent application 2 817 488, or by the method described in French patent application 2 842 514.

The aluminosilicate polymers of the imogolite type used in the invention are hollow nanotubes 2 nm in diameter and with a length of several microns. As already stated, they are obtained by controlled co-hydrolysis of aluminum salts and silicon alkoxides. This hydrolysis is followed by a thermal treatment that will permit growth of the filaments. These filaments will then be washed and concentrated by ultrafiltration. The structure of these aluminosilicate polymers of the imogolite type is very particular: the exterior of the tube is covered with Al—OH, whereas the interior of the tube is covered with Si—OH. Thus, the water remains trapped indefinitely inside the tube.

The aluminosilicate polymers of the allophane type used in the invention are hollow nanospheres 5 nm in diameter, also obtained by controlled co-hydrolysis of salts of aluminum and of silicon. In this case, however, hydrolysis is not followed by a thermal treatment, and the main parameter allowing either imogolite, or allophane to be obtained is the concentration of aluminum salts. This aluminosilicate polymer of the allophane type, like the aluminosilicate polymer of the imogolite type, is also covered with Al—OH on the outside and Si—OH on the inside. Similarly, in this aluminosilicate polymer of the allophane type, the core of the particle is filled with water.

The aluminosilicate polymers of the imogolite type and those of the allophane type are both amorphous. They are stable up to 300° C. and then decompose suddenly into H₂O, Al₂O₃ and SiO₂.

In this context, the invention aims to supply an agent for stabilizing peroxide ions in an open environment, i.e. in the air, for very long periods of time.

For this purpose, the invention proposes the use of particles of an aluminosilicate polymer of the imogolite and/or allophane type as an agent for stabilizing peroxide ions in the air, in particular when the latter are deposited on a substrate.

The invention also proposes a method of stabilizing peroxide ions in the air, characterized in that it comprises the following steps:
a) preparing a suspension comprising a solvent, particles of a polymer of the imogolite type and/or of the allophane type and a source of peroxide ions, and optionally a binder, and
b) drying.

In a preferred embodiment, the method of the invention further comprises, between steps a) and b), a step of depositing the suspension obtained in step a) on at least one substrate surface.

In all the embodiments of the method of the invention, the suspension preferably comprises a weight ratio of imogolite and/or allophane to peroxide ions between 3 and 0.5 inclusive.

In the preferred embodiment of the method of the invention, between 5 grams and 340 grams inclusive of particles of polymers of the imogolite type and/or of the allophane type are deposited per m² of substrate surface area.

The largest amounts of deposit are particularly suitable for applications as antibacterial agent.

In all the embodiments of the method of the invention, the source of peroxide ions is preferably hydrogen peroxide, and the solvent is water and can optionally comprise a film-forming organic binder that can be selected from: polyvinyl alcohol, hydroxypropylcellulose, starches and animal gelatins. Polyvinyl alcohol is preferred.

In fact, the presence of a binder in the dispersion may be necessary for holding the source of peroxide ions in place when the solvent is water.

The molar ratio of organic binder to imogolite or allophane polymer is selected in such a way that the layer is mechanically solid. In the case of heat exchangers, the molar ratio will typically be between 0.5 and 1 inclusive and much less than 1. Binder may not be needed in the case when mechanical solidity is not required, such as in the case of polymerization of unsaturated olefins. It will also be possible to add a mineral filler, which will participate in formation of the layer, such as colloidal silica, pyrogenic silica, alumina or clays (kaolin). These fillers only take part in formation of the layer and do not have any effect on the layer. Finally, the binder can be crosslinked by adding borax or formol so as to impart robustness to the layer.

The invention further proposes a substrate, characterized in that it comprises at least one surface coated with a layer comprising particles of a polymer of the imogolite type and/or of the allophane type and a source of peroxide ions.

Preferably, said layer comprises between 5 and 340 grams inclusive of particles of a polymer of the imogolite type and/or of the allophane type per m².

Preferably, said layer comprises a ratio of polymer of the imogolite type and/or allophane type to peroxide ions between 3 and 0.5 inclusive.

In a preferred embodiment, the substrate according to the invention further comprises, on the layer comprising particles of a polymer of the imogolite type and/or of the allophane type and a source of peroxide ions, a layer of drying oil, preferably of linseed oil or any other unsaturated polyolefin of natural or synthetic origin.

The invention also proposes a device, characterized in that it comprises at least one substrate according to the invention or obtained by applying the method or the use according to the invention.

The invention finally proposes a heat exchanger, characterized in that it comprises at least one substrate according to the invention or obtained by applying the method or the use of the invention.

The invention will be better understood and other details and advantages thereof will become clearer on reading the explanatory description that follows.

The invention aims to stabilize peroxide ions on the surface of a material, and said material can then be dried and stored at room temperature and in equilibrium with the ambient humidity over very long periods, of up to several years.

The peroxide ions thus stabilized remain available for performing oxidation reactions, in particular the oxidation of bacteria or for oxidation reactions of the double bond of unsaturated polyolefins.

In fact, unsaturated olefins are involved in the formation of double membranes of bacteria and other microorganisms; this oxidation inhibits the formation of biofilms on the surface of the layer formed.

In fact, the inventors discovered that aluminosilicate polymers of the imogolite type or of the allophane type, in particular those of synthetic or non-natural origin used either alone or in combination with one another, are materials that are particularly suitable for stabilizing peroxide ions on their surface.

This is due to the fact that the aluminosilicate polymers are objects that are hollow but not empty.

Firstly they are filled with the mother liquor of the synthesis medium, then during steps of washing and purification, they become filled with deionized water.

They therefore constitute nano-reservoirs of water.

Another important structural characteristic of aluminosilicate polymers of this type is their chemical anisotropy.

In fact, their external surface is covered with aluminol groups: Al—OH, whereas the internal surface is covered with silanol groups: Si—OH.

They therefore have an external surface of the basic type and an internal surface of the acid type.

Impregnation of this type of aluminosilicate with a liquid, in particular aqueous, source of peroxide ions will quickly lead to exchange of the water inside the particles of aluminosilicate polymers with the liquid source of peroxide ions.

The particles of aluminosilicate polymers of the imogolite type or allophane type then constitute nano-reservoirs of peroxide ions.

The very acid character of the surfaces covered with silanol groups contributes to the stabilization of these peroxide ions.

These particles can then be used in any way that seems suitable to a person skilled in the art, either as such, or deposited on the surface of the material to be treated with the peroxide ions.

In this case, the deposit will dry on the surface of the material to be treated, but the reservoirs “reservoirs of peroxide ions” will remain full of water and therefore of peroxide ions.

In fact, experiments conducted by the inventors showed that these reservoirs emptied at temperatures above 200° C.

Thus, a first object of the invention is the use of particles of a polymer of the imogolite type or of the allophane type, alone or in combination with one another as an agent for stabilizing peroxide ions in the air, and these particles of aluminosilicate polymers may or may not then be deposited on a substrate.

Particles, nanoparticles as defined above, i.e. imogolites, are to be understood as hollow tubular particles about 2 nm in diameter and with a length from 500 nm to 1 μm, and hollow spheres for the polymers of the allophane type having a diameter of 5 nm with 4 to 6 pores with a diameter of 0.7 nm at the surface.

The amount of peroxide ions that can be contained on these particles of polymers of the aluminosilicate type used in the invention depends, of course, on the source of peroxide ions.

However, generally speaking, it is possible to introduce a weight ratio of aluminosilicate polymer of the imogolite type and/or of the allophane type to peroxide ions between 3 and 0.5 inclusive.

As the source of peroxide ions, it is possible to use hydrogen peroxide, preferably hydrogen peroxide as it will exchange more easily with the water contained in the pores of the particles of aluminosilicate polymer of the imogolite and/or allophane type.

The invention also proposes a method of stabilizing peroxide ions in the air that comprises a first step of suspending the particles of an aluminosilicate polymer of the imogolite and/or allophane type preferably in the ratios stated above, in a solvent and a source of peroxide ions, then evaporation of the solvent.

The solvent can be selected from any solvent of the source of peroxide ions compatible with the source of peroxide ions that will not dissolve or will not degrade the particles of the aluminosilicate polymer of the imogolite and/or allophane type. In particular, the solvent is water, optionally a water/alcohol mixture.

In a preferred embodiment of the method of stabilizing peroxide ions in the air, after suspending the particles of polymer of the imogolite type and/or allophane type and the source of peroxide ions in the solvent, and before drying, the suspension is deposited on at least one substrate surface.

In this case, preferably the solvent also comprises an organic binder, preferably water-soluble, and film-forming, i.e. forming a film during evaporation of the solvent.

An example of a water-soluble organic binder of this kind is polyvinyl alcohol (PVA).

Preferably, in this embodiment of the method of the invention, between 5 and 340 grams inclusive of particles of imogolite and/or of allophane laden with a source of peroxide ions is deposited per m² of surface covered.

In general, the solvent is water. However, for forming bacteriostatic films that will have to display mechanical stability for several years but will be obtained by depositing an aqueous solution containing a water-soluble organic binder, a polymer of imogolite and/or of allophane containing peroxide ions and chemical additives intended to consolidate the layer after drying operations (crosslinking agents) and optionally another “neutral” mineral filler. In contrast, for “centrifugal” polymerization (from the inside to the outside) of unsaturated olefins, it is not necessary to have a particular mechanical durability of the nano-reservoirs of peroxide ions, an aqueous colloidal sol of an allophane polymer and/or of imogolite containing peroxide ions is sufficient. The substrate is then dried to evaporate the solvent, and impregnated with the unsaturated olefins to be polymerized.

The substrate obtained by the use according to the invention or the method according to the invention therefore comprises at least one surface coated with a layer comprising particles of an aluminosilicate polymer of the imogolite and/or allophane type and a source of peroxide ions.

The peroxide ions are stored and stabilized, even in the air, on this substrate.

“Stabilization in the air” means stabilization in the open air, i.e. in an open environment.

Preferably, the amount per m² of surface area of the substrate covered with particles of an aluminosilicate polymer of the imogolite and/or allophane type serving as reservoir for the peroxide ions is between 5 and 340 grams inclusive.

More precisely, the weight ratio of aluminosilicate polymer of the imogolite and/or allophane type to peroxide ion, of the layer coating at least one surface of the substrate is between 3 and 0.5.

The substrate can be, for example, a surface to be varnished, especially when the varnish is a linseed oil.

The peroxide ions will then serve for polymerization of the linseed oil or of any other drying oil, such as natural or synthetic aliphatic olefins. As natural drying oils, we may mention the natural oils constituted predominantly of α-linolenic acid, or of linoleic acid or of oleic acid or of a mixture of these three acids.

In fact, linseed oil is a polyolefin that contains unsaturation sites.

The formation of the varnishes requires oxidation of these double bonds.

Linseed oil and other natural oils of the same type will be used for replacing the polymers derived from petroleum, which not only are toxic but also are not in accord with the policies of sustainable development adopted in industrialized countries.

Thus, quite soon, in treatments and stabilization, for example, with wood, the drying oils will replace the varnishes currently used in this market segment.

However, it is difficult to control the polymerization of drying oils, especially for obtaining thick coatings, as the oxygen of the air, which is the main oxidant, has difficulty diffusing to the deeper layers, leading to inhomogeneous polymerization between the surface of the varnish and the deeper layers of the varnish.

Thus, based on the invention, the surface to be varnished is treated beforehand with the suspension of aluminosilicate polymers of the allophane and/or imogolite type laden with peroxide ions, then dried, for example by stoving, then impregnated with drying oil.

The peroxide ions contained in the nano-reservoirs of the aluminosilicate polymer of the allophane and/or imogolite type will then diffuse from the inside to the outside and take part in the polymerization of the oil, whereas the surface of the varnish will be oxidized by the air.

The polymerization is then homogeneous without needing to add hazardous products such as peracids or lead salts to the oil.

Polymerized drying oils are extremely resistant—they were used as varnish at the time of the Renaissance.

They are very light-fast.

They can also be used in packaging, for providing protection against humidity, of solar panels.

Thus, the invention also proposes a substrate characterized in that it comprises at least one surface coated with a layer comprising particles of an aluminosilicate polymer of the allophane and/or imogolite type, and a source of peroxide ions, said layer itself being coated with a layer of drying oil, preferably linseed oil.

In these applications, the polymers of imogolite and/or of allophane can be natural or synthetic polymers of imogolite and/or of allophane that are not of high purity.

However, the agent of the invention for stabilization in the air can also be used to form bacteriostatic surfaces for long-term use.

In fact, keeping a surface free from all microorganisms is a very difficult challenge to meet without using mixtures of biocides that are more or less toxic to the handlers and users or without using expensive compounds such as silver salts.

In particular, in the area of heat exchangers, when a wall has a proliferation of microorganisms such as bacteria, yeasts, molds, or even cyanobacteria, the latter will isolate the walls of the exchanger on the air side, and the thermal performance will decrease.

Moreover, the bacteria and other microorganisms will decompose and generate olfactory pollution, as in the case of air conditioners, or will even participate in degradation of the metal by bacterial corrosion.

Now, microorganisms are very sensitive to the presence of peroxide ions as they are incapable of growing on surfaces bearing said chemical functions, as the peroxide radicals oxidize the double bonds of the fatty acids forming their membranes.

Thus, with the method of the invention, deposition by spraying, dipping, or painting of particles of an aluminosilicate polymer of the imogolite and/or allophane type laden with peroxide ions on the surface of the exchanger should be able to control the growth of the microorganisms for long periods of time.

This deposit can be used in automotive air conditioning and in air purifiers.

Thus, the invention also proposes a device that comprises at least one substrate, in its turn comprising at least one surface coated with a layer comprising particles of a polymer of the imogolite type and/or allophane type and a source of peroxide ions.

This device is in particular a heat exchanger.

In these applications, the polymers of imogolite and/or of allophane used are pure.

For better comprehension of the invention, some practical examples will now be described, purely for purposes of illustration, and nonlimiting.

For the purpose of demonstrating the unique capacity of the aluminosilicate polymers of the imogolite type and/or of the allophane type for very long-term storage of peroxide radicals on dry films, the following protocol was used.

It is known that in the presence of hydrogen peroxide and starches or compounds of starches, iodide ions are oxidized to iodine.

This reaction leads to a strong orange-yellow coloration.

This oxidation only takes place in the presence of hydrogen peroxide.

Thin layers were therefore produced from an aqueous suspension containing four different types of aluminosilicates:
1) aluminosilicate polymer of the pure imogolite type,
2) aluminosilicate polymer of the pure allophane type,
3) silica-alumina mixture in a ratio Al/Si=2,
4) halloysites. The halloysites are hollow particles of aluminosilicates having a molar ratio Al/Si=2, marketed by the company Aldrich.

The suspension also contains a water-soluble binder so as to obtain layers that are mechanically stable, without cracking, for long periods of time.

In the following examples, this binder is either gelatin, or polyvinyl alcohol (PVA).

The suspension also contains cyclodextrin as starch derivative and hydrogen peroxide at 30 vol %.

The proportions of the various constituents in the examples given below are identical.

The layers were produced by dipping or by direct deposition of droplets on microscope slides, and drying was carried out at room temperature and in the air for two days.

After drying for two days, a drop of an aqueous solution of sodium iodide (2 wt %) is deposited on the dry layer, in equilibrium with the ambient water vapor.

If the thin layer contains available peroxide ions, it will turn deep orange.

The experiments are repeated over five weeks on layers stored in the same conditions.

### EXAMPLE 1

3.12 g of PVA (PVA 4-88; M_{w}˜31 000; [CAS: 9002-89-5]; Batch: 454841/2; Fluka), 1 g of β-cyclodextrin (origin: Aldrich) and 3 ml of 30 vol % H₂O₂ are added to a solution of 75 ml of a polymer of pure allophane (9.6 g/l in Al+Si). The allophane/peroxide ions weight ratio is 0.7. This reaction mixture is heated to dissolve the polyvinyl alcohol. 5 glass plates are coated, then stored and dried at room temperature and at a relative humidity of 50%. 113 g of allophane polymer “laden with peroxide ions” were deposited per m² of surface of the glass plate.

### EXAMPLE 2 (COMPARATIVE)

1 g of β-cyclodextrin and 3 ml of 30 vol % H₂O₂ are added to 75 ml of a solution of PVA (PVA 4-88; M_{w}˜31 000; [CAS: 9002-89-5]; Batch: 454841/2; Fluka) at 4 wt %. A series of 5 glass plates is coated, then stored and dried at room temperature and at a relative humidity of 50%.

These plates are blanks, which demonstrate the difficulty of storing peroxide ions in an air-dried layer.

### EXAMPLE 3

The procedure in example 1 was followed, but with gelatin as the water-soluble binder (Gelatin from bovine skin, Type B; [CAS: 9000-70-8]; Batch: 115K0144; Sigma-Aldrich). The mineral filler/binder weight ratio is 0.24.

This example shows that the nature of the organic binder does not explain the observed phenomena of storage and stabilization of the peroxide ions.

### EXAMPLE 4

The procedure in example 1 was followed, but in this case β-cyclodextrin is not added. A series of 5 glass plates is coated, then stored and dried at room temperature and at a relative humidity of 50%.

The presence of peroxide ions is revealed by adding a solution containing iodide ions plus β-cyclodextrin on the glass plates.

This example was carried out to verify that the observed effects of stabilization of the peroxides were not due to a particular interaction of the allophanes with β-cyclodextrin.

### EXAMPLE 5 (COMPARATIVE)

75 ml of a colloidal suspension is prepared containing nanoparticles of silica and of alumina (LUDOX® CL colloidal silica 30 wt % suspension in H₂O; [CAS: 7631-86-9]; Batch: 13701KE; Sigma-Aldrich) and nanoparticles of Al₂O₃ (Aluminum oxide, NanoTek® AL-6050, 23% in H₂O, colloidal dispersion; [CAS: 1344-28-1]; Batch: 1107896; ABCR), the Al/Si molar ratio of the dispersion of nanoparticles is 2 and the pH of the colloidal suspension is 4.16 (similar to the pH of the suspension of allophane and/or imogolite); 3.12 g of PVA (PVA 4-88; M_{w}˜31 000; [CAS: 9002-89-5]; Batch: 454841/2; Fluka) is added to this suspension, the mineral filler/binder weight ratio is 0.24. Then 1 g of β-cyclodextrin and 3 ml of 30 vol % H₂O₂ are added. The reaction mixture is heated to dissolve the PVA completely and it is then coated on glass plates. 5 glass plates are coated, then stored and dried at room temperature and at a relative humidity of 50%.

The purpose of example 5 is to show that the fact of having nanoparticles of silica or of alumina does not explain the phenomena observed.

### EXAMPLE 6

75 ml of a colloidal suspension of halloysite (0.75 g) is prepared; halloysites are hollow nanoparticles of aluminosilicate with an Al/Si molar ratio =1, sold by Aldrich), the proportion by weight of nanoparticles is identical to the proportion by weight of allophane in example 1 and the mineral filler/organic binder ratio is 0.24. For this purpose, 3.12 g of PVA (PVA 4-88; M_{w}˜31 000; [CAS: 9002-89-5]; Batch: 454841/2; Fluka), 1 g of β-cyclodextrin (origin: Aldrich), 1 g of β-cyclodextrin and 3 ml of 30 vol % H₂O₂ are then added. The reaction mixture is heated to dissolve the polyvinyl alcohol.

5 glass plates are coated, then stored and dried at room temperature and at a relative humidity of 50%.

The purpose of this example is to show that the fact that the filler is an aluminosilicate and that the nanoparticles are hollow objects does not explain the properties observed.

### EXAMPLE 7

3.12 g of polyvinyl alcohol (PVA 4-88; M_{w}˜31 000; [CAS: 9002-89-5]; Batch: 454841/2; Fluka), 1 g β-cyclodextrin (origin Aldrich) and 3 ml of 30 vol % H₂O₂ are added to a solution of 75 ml of polymer of pure imogolite (27.9 g/l in Al+Si). The imogolite/peroxide ions weight ratio is 2. This reaction mixture is heated to dissolve the polyvinyl alcohol. 5 glass plates are coated, and dried and then stored at temperature and at a relative humidity of 50%. 330g/m² of surface area of the plate of pure imogolite polymer laden with peroxide ions was deposited.

This example shows the effectiveness of the aluminosilicate polymers of the imogolite type for storage and stabilization of peroxide ions.

### EXAMPLE 8: RESULTS

The following table summarizes the results of the experiments in examples 1 to 7.

| Experiments | Week 1 | Week 2 | Week 3 | Week 4 | Week 5 |
|---|---|---|---|---|---|
| Exp 1 | 1 | 1 | 1 | 1 | 1 |
| Exp 2 | 4 | 4 | 4 | 4 | 4 |
| Exp 3 | 2 | 2 | 2 | 2 | 2 |
| Exp 4 | 1 | 1 | 1 | 2 | 2 |
| Exp 5 | 2 | 3 | 4 | 4 | 4 |
| Exp 6 | 1 | 3 | 4 | 4 | 4 |
| Exp 7 | 1 | 1 | 1 | 1 | 1 |

Week 1 is time 0, i.e. the coatings have 2 days of drying at temperature and at a relative humidity of 50%.

For the other weeks, there is an increment of aging of 1 week between each test.

In this table, a score of 1 corresponds to strong coloration.

This strong coloration is evidence of the presence of a large amount of available peroxide ions.

Example 2, after 5 weeks, corresponds to a score of 4 in the table.

The scores from 1 to 4 in the table therefore correspond to a decreasing order of coloration and therefore of the amount of peroxide ions still present in the “dry” coating.

Examples 1, 3 and 4 correspond to the examples of the invention.

It can be seen that after drying for 5 weeks, the peroxide ions are still present.

The nature of the binder has little effect. The peroxide ions are sufficiently mobile to react in the system β-cyclodextrin and NaI (example 4).

Example 2 shows that after 2 days of drying in a layer composed of PVA, peroxide ions are no longer available.

Examples 4 and 5 show that the layers are not completely dry after drying for 2 days in air and that peroxides are still available, but 15 days later there are no longer any peroxides. Therefore the effect of stabilization and storage of the peroxides is not due to the presence of a mineral filler, the effect of storage is not due to the nature of the aluminosilicate of the allophane and/or imogolite type and the effect of this storage is also not due solely to the hollow character of the nanoparticles of the allophane or imogolite type, the halloysites being hollow aluminosilicates.

1. The use of particles of an aluminosilicate polymer of the imogolite and/or allophane type as an agent for stabilizing peroxide ions in the air.

2. The use of particles of polymers of the imogolite type and/or of the allophane type for stabilizing peroxide ions, deposited on a substrate, in the air.

3. A method of stabilizing peroxide ions in the air, wherein it comprises the following steps:
a) preparing a suspension comprising a solvent, particles of polymers of the imogolite type and/or of the allophane type and a source of peroxide ions, and optionally a binder, and
b) drying.

4. The method as claimed in claim 3, wherein it comprises, between steps a) and b), a step of depositing the suspension obtained in step a) on at least one substrate surface.

5. The method as claimed in claim 3, wherein the suspension comprises a weight ratio of imogolite and/or allophane/peroxide ions between 3 and 0.5 inclusive.

6. The method as claimed in claim 4, wherein between 5 grams and 340 grams inclusive of particles of polymers of the imogolite type and/or of the allophane type are deposited per m² of substrate surface area.

7. The method as claimed in claim 3, wherein the source of peroxide ions is hydrogen peroxide.

8. The method as claimed in claim 3, wherein the solvent is water and the binder is polyvinyl alcohol.

9. A substrate, wherein it comprises at least one surface coated with a layer comprising particles of polymers of the imogolite type and/or of the allophane type and a source of peroxide ions.

10. The substrate as claimed in claim 9, wherein said layer comprises between 5 and 340 grams of particles of polymers of the imogolite type and/or of the allophane type per m².

11. The substrate as claimed in claim 9, wherein said layer comprises a weight ratio of imogolite and/or allophane/peroxide ions between 3 and 0.5.

12. The substrate as claimed in claim 9, wherein it further comprises, on the layer comprising particles of polymers of the imogolite type and/or of the allophane type and a source of peroxide ions, a layer of drying oil, preferably of linseed oil.

13. A device, wherein it comprises at least one substrate as claimed in claim 9.

14. A heat exchanger, wherein it comprises at least one substrate as claimed in claim 9.
